(19) United States
(12) Patent Application Publication
(10) Pub. No.: US 2010/0114947 A1
(43) Pub. Date: May 6, 2010

(54) Online web search based business-to-business interaction system

(76) Inventor: Afshin Eftekhari, Anaheim, CA (US)

Correspondence Address: Afshin Eftekhari, 6723 E. Swarthmore Dr., Anaheim, CA, 92807, US

(21) Appl. No.: 12/290,845

(22) Filed: Nov. 3, 2008

(51) Int. Cl. G06F 17/30; G06F 7/00

(52) U.S. Cl. 707/770; 707/E17.108

(57) ABSTRACT

An online web search based business-to-business interaction system that facilitates simultaneously viewing and browsing more than one search interface presented on a webpage In general, a webpage presented to the user by a web client can have more than one search engine interface, an instant messaging section (such as an HTML DIV), a video display section on the web page, a company profile display section, etc. The user need not open up additional browser windows just to conduct additional searches, etc. The webpage also provides instant messaging capabilities and company profile display capabilities. The display of the company profile is facilitated by the company profile display module. When a company profile is searched by a user, and a target company profile is determined, it is displayed in a company profile section/pane or optionally in a main screen area. The target profile comprises contact information, product information, video information, such as a CEO's presentation, etc. Thus, a user can locate/search company profiles and be able to interact with those companies, thereby conducting business-to-business interactions.

### TECHNICAL FIELD

The present invention relates generally to Internet browsing and more particularly to searching for company profiles at a business oriented website.

### RELATED ART

Today, most of the online trade between buyers and sellers is facilitated by websites that provide information to users and some support for product selection. Most of these are aimed at consumers, and an individual can purchase an item such as a book, or a TV, online. There are several shortcomings with the type of websites and information provided for such online users. For example, a user has to browse through a product catalog pages first, select some products, then transition to a shopping cart page and then go through some payment process. This involves several different types of web pages and complicated navigation between them. Often, the user is required to go back and forth between these webpages, especially in order to add yet another product for purchase, or to get some additional details on a product selected. Such jumping back and forth between pages or viewing pieces of information on multiple open windows is tedious. The user interface is inadequate and user interactions across several webpages presented in a plethora of windows kept open is tedious and non-intuitive.

Having to open more than one window to search more than one piece of information and having to move back and forth between several open windows is not only cumbersome but also tedious for most users. Often, users open up a Google search window to find search some particular information, then open up a Yahoo search window to search for some other information, etc. If one web search engine does not provide the required information, the user is likely to search in another window employing a different search engine.

Sometimes users search on the Internet for a company to partner with, then get some details of that company from its website. Later, they open up another window and retrieve contact information from the company's website. Then they send an email using the contact information to get in touch with a company representative. Thus, such interactions require opening several windows on a PC/computer, browsing through such open windows, noting down contact information, etc. and subsequently using the contact information, such as in a request for product information or pricing information. Currently, there are few means by which this process can be made easier or speeded up, or made more efficient.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of an online web search based business-to-business interaction system 105 facilitates simultaneously viewing and browsing more than one search interface presented on a webpage;

FIG. 2 is a perspective block diagram of a network wherein a cooperating web server and web client make it possible for a user to interact with more than one search engine servers from the same web page/web client window;

FIG. 3 is a perspective block diagram of a network wherein a user employing a PC/computer with browser is able to search simultaneously (from the same web page or window) on more than one search engine server such as Google, Yahoo etc.;

FIG. 4 is an exemplary webpage provided by a web server built in accordance with the present invention that is displayed by a web client in order to enable simultaneous access to more than one search engine interface;

FIG. 5 is a flow chart of an exemplary operation of the online web search based business-to-business interaction system that facilitates searches for company profiles and interactions with targeted companies, all from a single web page; and

FIG. 6 is a flow chart of an exemplary operation of the online web search based business-to-business interaction system wherein the user can search and retrieve a target company profile and subsequently interact with the target company using the web client.

### DETAILED DESCRIPTION OF THE DRAWINGS

The present invention makes it possible to have a website/portal based interactive navigation system that enables a user, using a web client on a PC or computer, to simultaneously and actively search and navigate different company websites and Internet portals. Individual customers who subscribe to, or access the website/portal, can create or upload their company profiles and search other profiles for their partner companies. The present invention eliminates the need to open multiple browsers or tabs in Internet programs, such as browsers, and makes search and discovery using multiple search engines or services much easier. A user can actively navigate through any of the one or more search and browsing panes/windows that are presented, that are simultaneously open, using the web client. The web customer of the web portal based interactive navigation system, who does not have a custom company website with an accessible public company profile, can create a new profile on the web portal. In general, the user can simultaneously open up one or more browsing panes to search and retrieve partner information, or search for new partner companies and browse their profiles.

In general, the user can simply select a search interface on the default webpage provided by a website, built in accordance with the present invention that comprises a plurality of search interfaces. The user can then begin actively navigating through one or more search windows or browsing windows/panes.

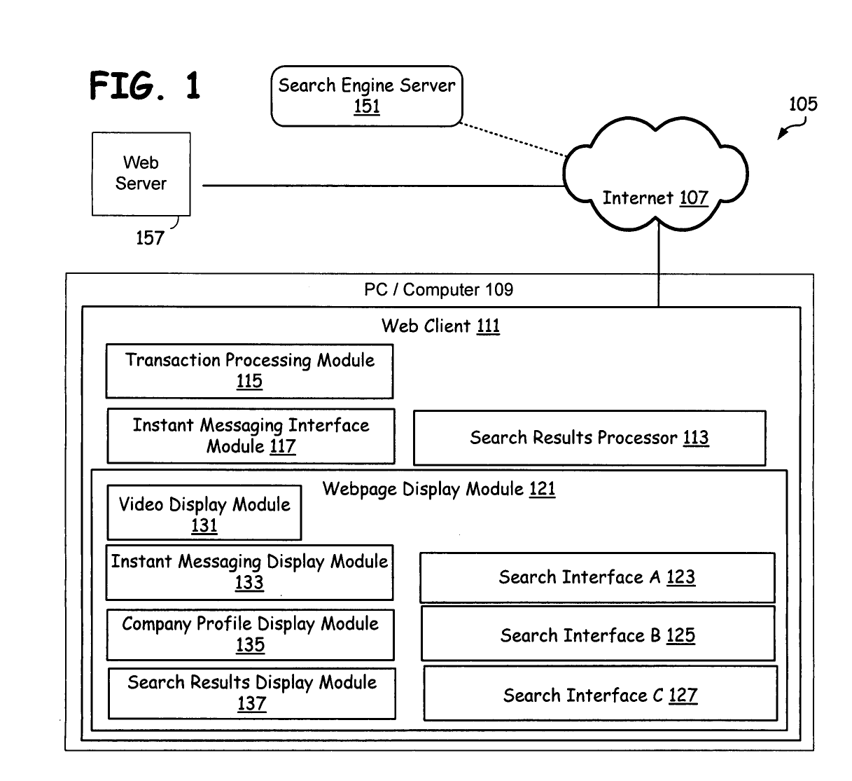

FIG. 1 is a perspective block diagram of an online web search based business-to-business interaction system 105 that facilitates simultaneously viewing and browsing more than one search interface presented on a webpage. The online web search based business-to-business interaction system 105 comprises a web server 157 communicatively coupled to a PC /computer 109 via Internet 107, and one or more search engine servers 151 communicatively coupled to the web server 157 and to the PC/computer 109. The PC/computer 109 comprises a web client 111 that is capable of presenting a plurality of search interfaces to the user on a webpage provided by the web server 157. The web client 111 comprises web page display module 121, a transaction processing module 115, an instant messaging interface module 131 and a search results processor 113. The web page display module 121 presents a search interface A 123, a search interface B 125, a search interface C 127. It comprises a video display module 131, an instant messaging display module 133, a company profile display module 135 and a search results display module 137.

The online web search based business-to-business interaction system 105 makes it possible for a user of the PC/computer 109 to be presented with a web page that provides a plurality of search engine interfaces, instant messaging capabilities as well as a display of company profiles that are selected. The search engine interfaces 123, 125, 127 make it possible to search and retrieve company profiles, and product information. The web client 111 communicatively coupled to the web server 157 is capable of providing a plurality of panes for simultaneously displaying search prompts, related results, and company profiles. The web server 157 is capable of simultaneously searching a plurality of other web servers and presenting retrieved results in the corresponding ones of the plurality of panes on the web client 111. For example, it can interact with a Google based search engine server, a Yahoo based search engine server, etc.

The web server 157 retrieves corresponding videos from at least one of a plurality of video servers on the Internet and displays them for selection by the user on the web client 111. The web client 111 enables simultaneous display of the retrieved results in the corresponding ones of the plurality of panes. It also enables displaying the corresponding videos on a video display pane managed by the web client 111. The web client 111 provides a company profile pane for facilitating optional company profile entry or update by the user.

The online web search based business-to-business interaction system 105 interacts with search engine server 151 such as a Google search engine server, a Yahoo search engine server, a Baidu search engine server, a MSN search engine server and a YouTube server. The online web search based business-to-business interaction system 105 comprises the web client 111 that facilitates simultaneous searches across a plurality of search engines. Each of the plurality of search engines display their results in a corresponding one of the plurality of panes. In one embodiment, the online web search based business-to-business interaction system 105 presents a plurality of panes on the same web page, wherein each of the plurality of panes provide access to one of a plurality of search services. The plurality of search services comprise a Google search service, a Yahoo service and an Microsoft search service. The user can use any of the search services to search for a target company profile, and then interact with contacts provided for the target company.

In one embodiment, the online web search based business-to-business interaction system 105 includes the web client 121 that enables a user to simultaneously and actively search and navigate different websites and portals employing the plurality of panes. Each of the plurality of panes presented by a web page (that is provided by the web server 157, for example) provides one of the search services (for example, Google based, Yahoo based, etc.). The user can search and retrieve company profiles of other companies (such as potential partners) that the user is interested in interacting with, and review the company profiles in the plurality of panes. The web client also enables a user to set up a company profile that is stored locally at the web server 157 or to reference a remotely stored company profile stored on an external web server.

In general, the same webpage presented to the user by the web client 111 can have more than one search engine interface, an instant messaging section (such as an HTML DIV), a video display section on the web page, a company profile display section, etc. The user need not open up additional browser windows just to conduct additional searches, etc. The webpage also provides instant messaging capabilities and company profile display capabilities. The display of the company profile is facilitated by the company profile display module 135. When a company profile is searched by a user, and a target company profile is determined, it is displayed in a company profile section/pane or optionally in a main screen area. The target profile comprises contact information, product information, video information, such as a CEO's presentation, etc. Thus, a user can locate/search company profiles and be able to interact with those companies, thereby conducting business-to-business interactions. Results of searches for target companies are displayed with the help of the search results display module 137. Instant messaging based interactions with contacts provided by target companies is facilitated by the instant messaging display module 133.

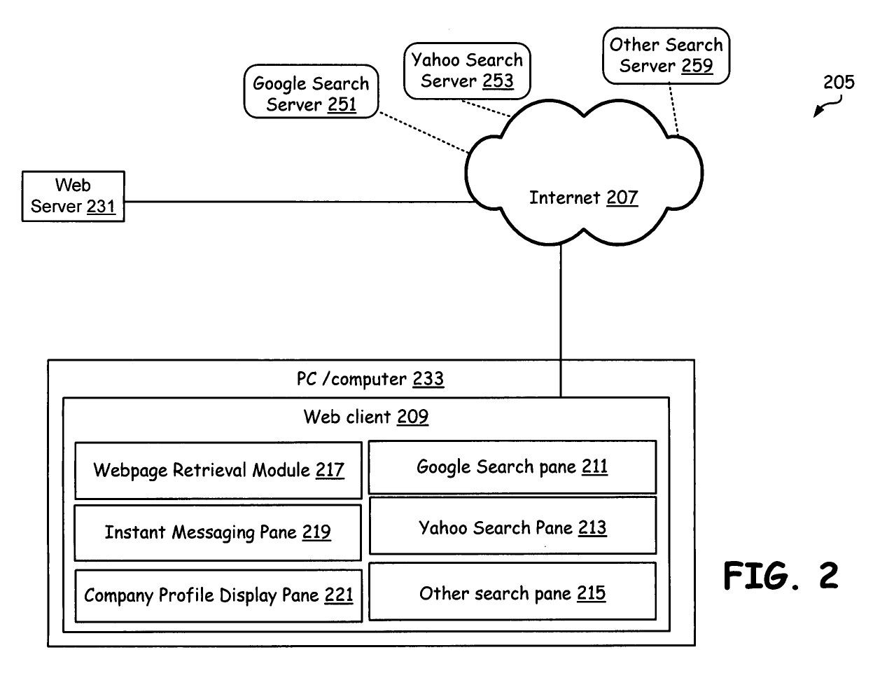

FIG. 2 is a perspective block diagram of a network 205 wherein a cooperating web server 231 and web client 209 make it possible for a user to interact with more than one search engine servers from the same web page/web client 209 window. The web client 209 is executed/used in a PC/computer 233 and it provides window search interfaces employing search panes 211, 213, 215. The search interfaces facilitate interactions with corresponding search servers, via the web server 231 or directly with the search servers. For example, a Google search pane 211 facilitates interactions with a Google Search server 251. In one embodiment, it can be directly interacting with the Google Search server 251, and in a related embodiment, it interacts with the Google Search server 251 via the web server 231.

The web client 209 comprises a Google search pane 211, a Yahoo search pane 213 and another search pane 215 (a placeholder that can be used when needed). It also comprises a web page retrieval module 217, an instant messaging pane 219 for presenting instant messages during online messaging interactions, and a company profile display pane 221 for presenting company profiles of target companies.

In one related embodiment, the web client 209 is an Internet browser software that runs on the PC/computer 233, such as an Internet Explorer browser or a Firefox browser. The web server 231 presents a web page that comprises the Google search pane 211, the Yahoo search pane 213 and the another search pane 215.

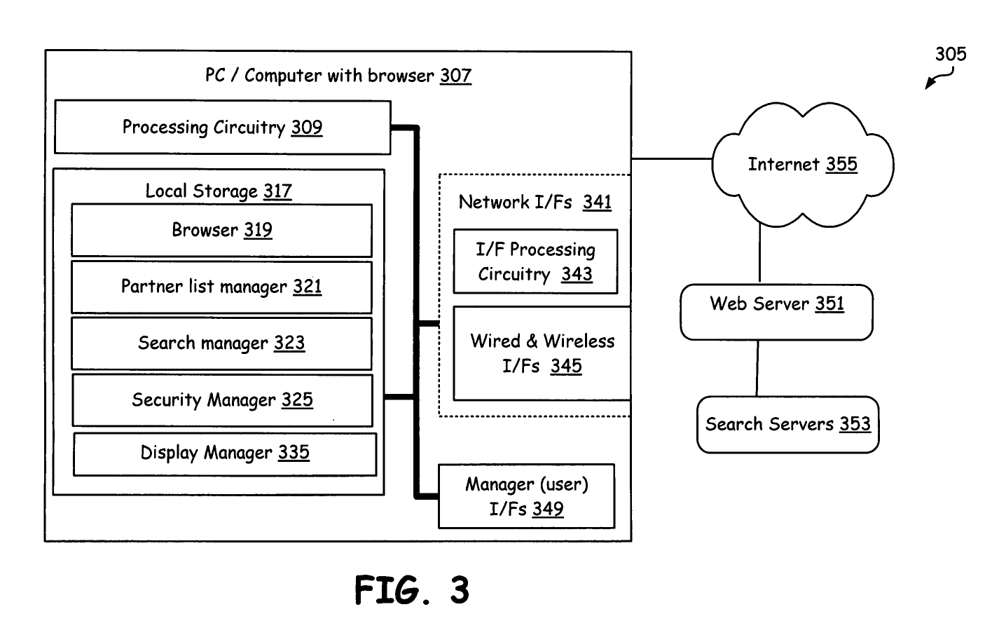

FIG. 3 is a perspective block diagram of a network wherein a user employing a PC/computer with browser 307 is able to search simultaneously (from the same web page or window) on more than one search engine server such as Google, Yahoo etc. The PC/computer with browser 307 comprises a processing circuitry 309, a local storage 317, a network interface 341 and a user manager interface 349. The network interface 341 comprises an interface processing circuitry 343 and a wired & wireless interface 345. The local storage 317 comprises a plurality of programs that can be executed on the processing circuitry 309. It comprises a browser 319, a partner list manager 321, a search manager 323, a security manager 325 and a display manager 335. The browser 319 can employ the other software components available in local storage 317 or others that it can download as necessary.

Using the browser 319, a user of the PC/computer with browser 307 can work on webpages provided by the web server 351, such as those that comprise search interfaces to search servers 353. For example, the browser 319 can be a an Internet Explorer browser from Microsoft and the search servers 353 comprise of a Google search server and an Yahoo search server. The web server 351 provides a web page to the user of the PC/computer with browser 307 wherein the web page has search sections (such as panes implemented by html DIVs) for both Google and Yahoo based search engine servers 353.

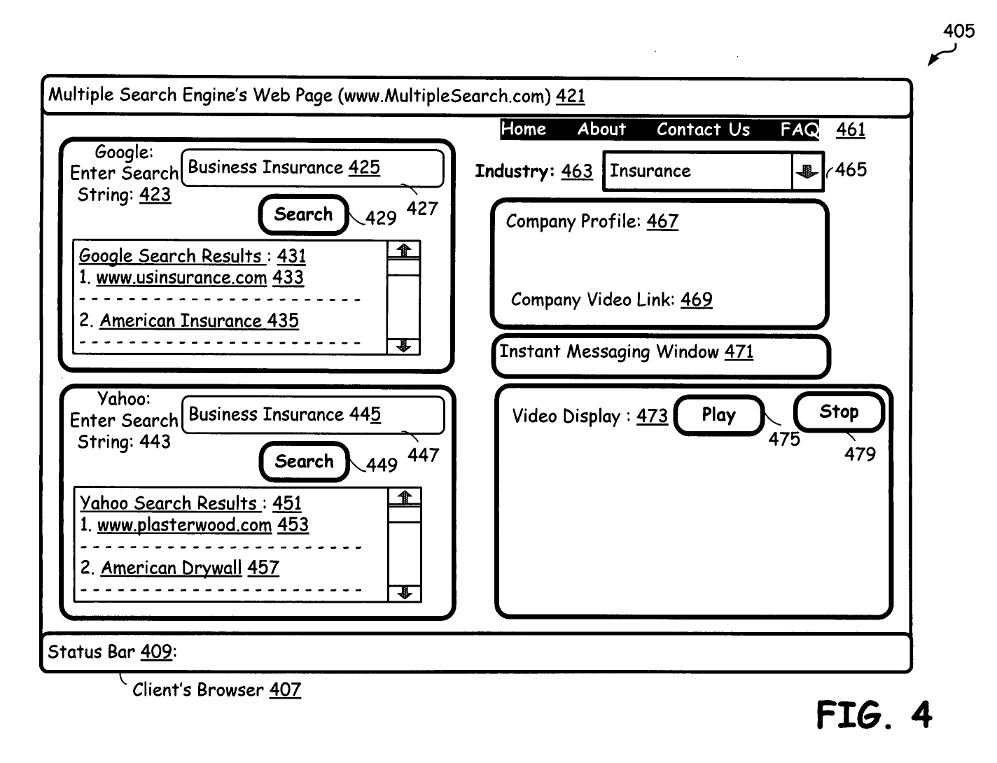

FIG. 4 is an exemplary webpage 421 provided by a web server built in accordance with the present invention that is displayed by a web client in order to enable simultaneous access to more than one search engine interface. The web page 421 comprises a Google search section 423, a Yahoo search section 443, a status bar 409, a tool bar 461, an industry selection dialog box section 463, a company profile section 467, an instant messaging section 471, and a video display section 473. The web page 421 is displayed by a client browser 407 that is typically executed on a PC or computer.

The user can select an industry category using the industry selection dialog box section 463. Based on user's industry selection, the searches in the Yahoo search section 443 and the Google search section 423 are guided/filtered. Further search criteria can be specified by the user in each of the individual search sections 423, 443 to fine tune the searches and retrieve relevant search results. The search results are displayed in appropriate search results sections 431, 451. If the user selects one of the displayed results, such as a target company listed, the company profile section 467 is populated by details from a target company webpage retrieved. In addition, the video display section 473 is populated with available videos, such as a presentation from a CEO of the company that s retrieved from a YouTube server. Also, the instant messaging section 471 is also activated with a contact information for a person or group associated with the target company. The toolbar section 461 provides links for default web pages such as those for homepages and for restarting searches.

The Google search section 423 comprises a search string input section 425, a search activation button 429 and the search results display section 431 that lists results, such as a list of company profiles of potential target companies. Similarly, the Yahoo search section 443 comprises a search string input section 445, a search activation button 449 and the search results display section 451 that lists results, such as a list of company profiles of potential target companies. The status bar 409 indicates status information, such as status of searches being conducted, company profiles currently displayed, status of video being downloaded for display, etc.

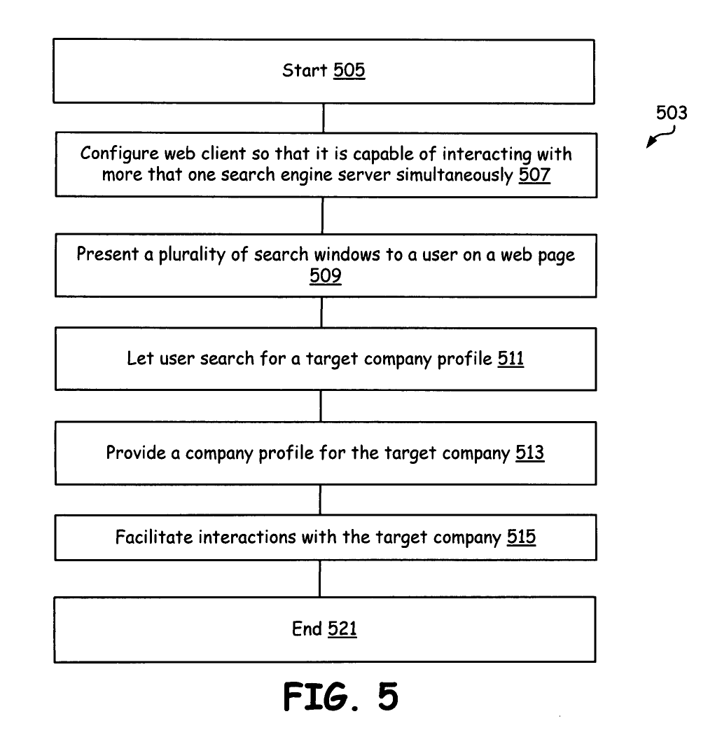

FIG. 5 is a flow chart of an exemplary operation of the online web search based business-to-business interaction system 105 that facilitates searches for company profiles and interactions with targeted companies, all from a single web page. At a start block 505, operation starts where a user starts the web client (such as a browser built in accordance with the present invention). Then, at a next block 507, the web client is configured such that it is capable of interacting simultaneously with more than one search engine server. Then, the user is presented a webpage with a plurality of search windows on the same web page. Thus, for example, a webpage presented to the user can be used to interact with a Google search engine from one section of the web page and a Yahoo search engine from another section of the same web page.

Then, at next block 511, the search for a target company profile is facilitated when the user employs one or more of the plurality of search windows/panes that is presented by the web client (based on webpage provided by a web server, for example). The results of such a search are presented to the user for review. Then, at a next block 513, a target company profile is retrieved and presented to the user, when the user selects one of the companies listed as a part of the search results. The user can select one of the listed companies in the search results and it will be designated as the target company, and a webpage (one or more web pages) associated with the company profile are retrieved and presented to user.

Then, at a next block 515, interactions by the user with the target company is facilitated. Such interactions can be via instant messaging facilities available, via email, etc. It can involve sales inquiries, sales transactions, etc. Then, at an end block 521, the operation terminates.

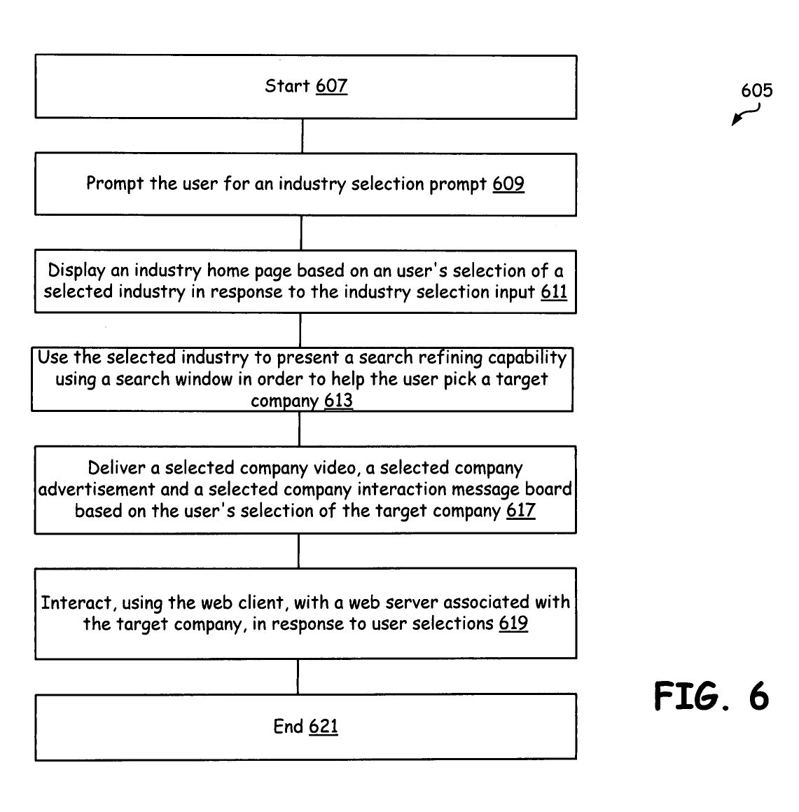

FIG. 6 is a flow chart of an exemplary operation of the online web search based business-to-business interaction system 105 wherein the user can search and retrieve a target company profile and subsequently interact with the target company using the web client. At a start block 607, the user logs into an account established with the online web search based business-to-business interaction system 105. Then, at a next block 609, the user is prompted for an industry selection prompt. The user can select one of the available categories of industry that is supported. For example, a drop down box enables the user to select an industry, such as “insurance”. Then, at a next block 611, the selected industry home page is presented to the user, based on the user's selection of a selected industry.

Then, at a next block 613, the search capabilities are configured with the user selected industry. For example, the filters for searches on available search interfaces, for search engine servers such as Google, Yahoo, etc. are setup with the selected industry to narrow the search if initiated. Thus, the selected industry is used to present a search refining capability using the search window/panes in order to help the user pick a target company. The user is presented with a list of target companies and he can select a target company from the list presented.

At a next block 617, the webpages associated with the selected target company are presented to the user along with links to videos and company profile. The The web server of the online web search based business-to-business interaction system 105 provides such webpages if it is stored there, or it retrieves them from an external server, as necessary, if references/links to such webpages have been configured. The user can view the target company profile, view a video provided for that target company, access contact information, etc. A video pane is populated with the link to the video, if any. AN instant messaging pane is configured with an instant messaging account information, as necessary.

Then, at a next block 619, the user, via the web client, interacts with the web server associated with the target company. The interactions can be via instant messaging, via email, etc. The user can view company profile and associated detail information provided by a webserver associated with the target company selected, or those hosted by the webserver associated with the online web search based business-to-business interaction system 105.

Finally, the operation terminates at the end block 621.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. An online web search based business-to-business interaction system comprising:
a web client communicatively coupled to a web server that is capable of providing a plurality of panes for simultaneously displaying search prompts, related results, and company profiles;
the web server capable of simultaneously searching a plurality of other web servers and presenting retrieved results in the corresponding ones of the plurality of panes on the web client;
the web server retrieving corresponding videos from at least one of a plurality of video servers on the Internet and displaying them for selection by the user on the web client;
the web client enabling simultaneous display of the retrieved results in the corresponding ones of the plurality of panes and also displaying the corresponding videos on a video display pane; and
the web client providing a company profile pane for facilitating optional company profile entry or update.

2. The online web search based business-to-business interaction system of claim 1 wherein the other web servers comprise at least one search engine server from a group comprised of a Google search engine server, a Yahoo search engine server, a Baidu search engine server and a MSN search engine server and wherein the plurality of video servers comprises a YouTube server.

3. The online web search based business-to-business interaction system of claim 1 wherein the web client facilitates simultaneous searches across a plurality of search engines wherein each of the plurality of search engines display their results in a corresponding one of the plurality of panes.

4. The online web search based business-to-business interaction system of claim 1 wherein the plurality of panes is presented on the same web page and wherein each of the plurality of panes provide access to one of a plurality of search services, wherein the plurality of search services comprise a Google search service, a Yahoo service and an Microsoft search service.

5. The online web search based business-to-business interaction system of claim 1 wherein the web client enables a user to simultaneously and actively search and navigate different websites and portals employing the plurality of panes.

6. The online web search based business-to-business interaction system of claim 5 wherein the web client enables a user to search and retrieve company profiles of other companies that the user is interested in interacting with and review the company profiles in the plurality of panes.

7. The online web search based business-to-business interaction system of claim 1 wherein the web client enables a user to set up a company profile that is stored locally at the web server or to reference a remotely stored company profile stored on an external web server.

8. An online web based browsing system comprising:
a web client capable of simultaneously providing a plurality of web search interfaces on a business interaction screen, each of the plurality of web search interfaces capable of employing one of a set of search engines comprising a Yahoo search engine, a Google search engine and an MSN search engine;
the web client, via the business interaction screen, supporting an industry category selection capability, interactive messaging capability, advertisement display capabilities and company profile retrieval and display capabilities;
the web client enabling search and retrieval of a target company profile employing any of the plurality of web search interfaces; and
the web client enabling interaction with one or more users associated with the target company via the interactive messaging capability.

9. The online web based browsing system of claim 8 further comprising:
a web server communicatively coupled to the web client that facilitates business interaction by a user via the web client, wherein the web server enables retrieval and display of profiles of one or more target companies and other related information by the user.

10. The online web based browsing system of claim 8 wherein the web client comprises:
an industry selection dialog box;
at least one search pane, each of the at least one search pane displaying one of the plurality of web search interfaces;
an interactive message board;
an advertisement pane; and
a company profile pane capable of displaying videos, graphics and text.

11. The online web based browsing system of claim 10 further comprising:
the web server processing a user request for a target company profile and product information based on the user's selection of an industry selection information on the industry selection dialog box and the user's specification of a search criteria on the at least one search pane; and
the web client providing the user with a target company profile on the company profile pane, a reference to a company video on the company profile pane, and a company advertisement on the advertisement pane.

12. The online web based browsing system of claim 8 further comprising:
the web client retrieving a target company profile via any of the plurality of web search interfaces; and
the web client displaying the target company profile for review by a user.

13. The online web based browsing system of claim 12 wherein the target company profile comprises a target company overview, a target company product and services information, a target company contact information, a reference to a video associated with the target company and a history of interactions with the target company.

14. A method of supporting online business-to-business interactions on the Internet wherein a web client is capable of interacting with at least one web server simultaneously, the method comprising:
presenting a plurality of search windows to a user on a web page provided by the at least one web server, wherein each of the plurality of search windows can be used to search for a target company to interact with;
providing a company profile for the target company; and
facilitating interactions with the target company.

15. The method of claim 14 further comprising:
prompting the user for an industry selection input;
displaying an industry home page based on an user's selection of a selected industry in response to the industry selection input; and
using the selected industry to present a search refining capability in at least one of the plurality of search windows in order to help the user pick the target company.

16. The method of claim 15 further comprising:
delivering a selected company video, a selected company advertisement and a selected company interaction message board based on the user's selection of the target company.

17. The method of claim 15 further comprising:
interacting, by the web client, with a web server associated with the target company, in response to user selections.

18. The method of claim 15 wherein the plurality of search windows can be simultaneously used to search for one or more company profiles and related information.

19. The method of claim 15 wherein the one or more company profiles retrieved by searching in the plurality of search windows can be selectively saved in a partner list maintained by the web client.

20. The method of claim 15 further comprising:
conducting sales transactions with the target company.
